(19) United States
(12) Patent Application Publication
(10) Pub. No.: US 2026/0197884 A1
(43) Pub. Date: Jul. 9, 2026

(54) METHOD OF OPERATING A LINEAR NETWORK

(71) Applicant: Continental Automotive Technologies GmbH, Hannover (DE)

(72) Inventors: David Gonzalez Gonzalez, Egelsbach (DE); Andreas Andrae, Frankfurt am Main (DE); Osvaldo Gonsa, Frankfurt (DE); Filipe Borges Teixeira, Porto (PT); Rui Campos, Santa Maria da Feira (PT); Tiago Oliveira, Porto (PT)

(73) Assignee: Continental Automotive Technologies GmbH, Hannover (DE)

(21) Appl. No.: 19/132,353

(22) PCT Filed: Nov. 17, 2023
(86) PCT No.: PCT/EP2023/082256

§ 371 Date: May 22, 2025

(30) Foreign Application Priority Data
Nov. 23, 2022 (DE) 10-2022 212 525.8

(51) Int. Cl. H04W 76/14; H04W 72/566; H04W 74/0833; H04W 76/15

(52) U.S. Cl. CPC H04W 76/14; H04W 72/566; H04W 74/085; H04W 76/15

(57) ABSTRACT

A method of operating an arrangement of a plurality of network nodes arranged in a linear configuration, each of which network nodes being capable of directly communicating with n neighbouring network nodes located in either direction of the linear arrangement of network nodes. Operation of the nodes includes determining and assigning an unambiguous and individual rank to each one of the plurality of network nodes. Each rank indicates a position of the respective network node within the linear network. The ranks orderly increase from one end of the linear arrangement of network nodes to the other end. The network nodes toggle between a first and a second mode of operation. A power consumption of the network nodes in the first mode of operation is lower than in the second mode. Messages are transmitted along the linear arrangement of network nodes using a non-synchronised, zero-signalling, stateless multipath and multi-hop message routing protocol, via network nodes that are in the second mode of operation.

### CROSS-REFERENCE TO RELATED APPLICATIONS

The present application is a National Stage Application under 35 U.S.C. § 371 of International Patent Application No. PCT/EP2023/082256 filed on Nov. 17, 2023, and claims priority from German Patent Application No. 10 2022 212 525.8 filed on Nov. 23, 2022, in the German Patent and Trademark Office, the disclosures of which are herein incorporated by reference in their entireties.

### FIELD

The present invention relates to operating of and communicating in linear networks, i.e., networks in which network nodes that are connected are arranged serially in a line, i.e., extending in one spatial dimension. Aspects of the present invention relate to network discovery, management of active and standby modes, data transfer or message passing, fault detection and reconfiguration in case of faults or changes in network topology.

### BACKGROUND

The ever-increasing use of sensors in all fields of technology and business and the corresponding data analysis brings about the need for accessing the sensor data. Local data storage in the sensor nodes requires physically “visiting” the sensor nodes for accessing and extracting the data, which can be cumbersome, invoke high cost, or generally be impractical.

As a consequence, more and more sensor nodes are equipped with communication interfaces that provide access to communication networks. Such “connected sensors” may transmit sensor data at regular intervals or in response to a corresponding request. Sensors may be connected through wired and/or wireless communication technologies. In many applications, wireless communication may be preferred.

Depending on the respective deployment of the sensor nodes the communication network may not be of the more common type like GSM, UMTS, LTE, WiFi or the like, in which any node may access a base station and the base station relays the data via a backbone network to a data sink or vice versa under control of a network management service. Rather, common-type communication networks may not be available at all, and data may need to be transmitted from one node to the next, each node relaying the data until the data finally arrives at the data sink.

A particular type of network is a linear network, in which all nodes are lined-up in a linear arrangement, and each node has a direct communication link only with a limited number of neighbouring nodes, e.g., due to the limited range of the wireless communication or due to the way wired connections are arranged.

An example for such linear network is found, e.g., in the oil and gas industry, where the transportation of fluids is typically made using a number of hose segments that are connected to form a long hose, particularly in underwater environments. For example, the transfer of crude oil from offshore tankers to onshore refineries is made using hoses deployed underwater. In these environments, the hoses are subject to adverse conditions, which can induce phenomena such as fluid leakages. This demands periodic hose monitoring, which preferably is performed by sensors arranged on the hose. Sensors attached to the hose segments may be used for monitoring the integrity of the hose segments and the connections. As wireless communication in seawater is limited in range, the sensor nodes need to communicate either via a wired network, which encumbers the flexible arrangement of hose segments as needed, or via short-range multi-hop wireless networks.

In multi-hop communication, in order for messages to pass from one end to the other end of the linear arrangement, or from any node within the serial arrangement to one or more other nodes, a message transmitted from one node is received by the neighbouring nodes within wireless range, and will have to be forwarded along the linear arrangement towards the intended recipient. Thus, in multi-hop communication, the message “hops” through a number of intermediate network nodes before it arrives at the intended message recipient.

Ideally, in multi-hop communication each node knows the arrangement of all nodes within the linear arrangement of network nodes, in which case only those nodes need to forward a message that are located between the transmitter and the receiver, saving energy in the other nodes. However, typically the nodes may at least initially not know at which location they are arranged within the linear arrangement of network nodes, and further, the nodes may not be statically arranged in the linear arrangement. Rather, the arrangement of the nodes may more or less dynamically change without notice. With regard to the example of a hose formed from connected hose segments, one or more network nodes may be attached to or arranged on a hose segment, and the arrangement of the segments and/or the orientation of the segments may change between uses. Further, the movement of the hose segments due to waves and the like may temporarily bring different network nodes within wireless range, effectively changing the arrangement of the network nodes within the linear arrangement of network nodes.

### BRIEF SUMMARY

There is, thus, a need for a discovery protocol that not only discovers the presence of the nodes, but also their position within the linear arrangement, and thereby offers greater flexibility when the nodes are arranged in the linear arrangement of network nodes or when the arrangement of the network nodes changes over time. In addition, there is a need for a protocol that governs the transport of messages along the nodes of the linear arrangement of network nodes. Further, there is a general need of controlling power or operating states of the nodes, for enhanced energy efficiency. Yet further, there is a need for detecting network nodes failing to participate in the transport of messages.

The methods and apparatuses detailed in the independent claims address the aforementioned needs. Advantageous embodiments and developments of the methods and apparatuses are provided in respective dependent claims.

In the context of this specification communication connections may be wired or wireless unless explicitly mentioned or obvious from the respective context. Wireless communication may include acoustic waves and electromagnetic waves, wherein the latter may be subdivided into optical communication, radio frequency electromagnetic communication and magneto-inductive communication. A linear network or topology is defined herein as a network in which each device or node is arranged one after the other in a sequential chain. It is assumed that communication may flow in both directions along the linear arrangement of network nodes and that each node is able to directly communicate with the n closest neighbours in each direction, with n>1, while no node is capable of directly communicating with all other nodes, e.g., due to limited range of the wireless transmitters or due to the arrangement of wired connections. The limited range of wireless communication may result from power limitation for legal or regulatory reasons or for power conservation, or due to environmental influences, e.g., underwater or in other environments that have a high attenuation for wireless signals or that exhibit noise that limits the range of the wireless communication. The communication amongst the nodes of the linear arrangement of network nodes thus uses multiple hops for permitting communication amongst all nodes. In multi-hop communication a transmitter transmits a message to one or more other nodes, and each node forwards the message until the message ultimately arrives at the intended target or recipient. Communication may, thus, include transmitting and receiving, though not necessarily simultaneously.

In accordance with a first aspect of the present invention, a method of operating an arrangement of a plurality of network nodes initially randomly arranged in a linear configuration is presented. Each of the nodes is configured to or capable of directly communicating with n neighbouring network nodes located in either direction on the linear arrangement of network nodes, e.g., via a wireless connection having a limited range, or via any other type of connection, e.g., cabled. However, no network node can directly communicate with each and every one of the other network nodes of the linear arrangement of network nodes. There will always be network nodes that are beyond the direct communication range of a transmitting node, i.e., typically those that will be located farther away from the transmitting node than the n-th network node. In this context, randomly arranged means that at least at the very beginning the network nodes have no prior knowledge of their respective positions in the linear arrangement of network nodes, nor of their neighbours within direct communication range. The method comprises determining and assigning an unambiguous and individual rank to each one of the plurality of network nodes. The rank of each network node has a major rank, and at least one network node has a minor rank. The ranks, that are orderly increasing from one end of the linear arrangement of network nodes to the other end, indicate a position of the respective network node within the linear arrangement of network nodes and with respect to its neighbouring nodes within direct communication range. The method further comprises configuring the plurality of network nodes to coordinated toggling between a first and a second mode of operation. A power consumption of the network nodes in the first mode of operation being lower than in the second mode of operation, e.g., by switching off components like a transceiver while in the first mode of operation. The method yet further comprises transmitting messages between the network nodes of the linear arrangement of network nodes using a non-synchronised or asynchronous, zero-signalling, stateless multipath and multi-hop message routing protocol, via network nodes that are in the second mode of operation. Coordinated toggling between a first and a second mode of operation may include switching all network nodes to the first or the second operating mode, such that at least for a certain time period all network nodes are in the second operating mode simultaneously, or switching selected ones of the network nodes to the first or second operating mode in such a way that network nodes within direct communication range of a transmitting network node and located in a direction of travel of a message that is forwarded through a chain of neighbouring network nodes are in the second operating mode. The direction of travel may also be considered a direction of information flow.

In one or more embodiments of the method, determining and assigning an unambiguous individual rank to each one of a plurality of network nodes comprises assuming, by a first network node located at a first end of the linear arrangement of network nodes, a first major rank, e.g., 0. The network node may do so in response to a command or initiation message received from a sink node that is communicatively connected to that end of the linear arrangement of network nodes, at which the first node is located, in such a way that the command is received only by the first node, e.g. through an electrical or optical wired connection or through a narrow-beam wireless connection. The first network node broadcasts a bootstrap message into the linear arrangement of network nodes, announcing its assumed major rank to those network nodes that are within direct communication range. After powering up for the first time and while not having determined and assigned an individual rank all nodes of the linear arrangement of network nodes are in the second mode of operation, i.e., being ready for receiving and transmitting messages, and will remain in the second mode of operation until a command is received in response to which the nodes are switched to the first operating mode. To up to n neighbouring network nodes within direct communication range of the first network node that receive the bootstrap message transmitted by the first network node, this bootstrap message is a respective first bootstrap message. The other network nodes outside of the wireless range will continue waiting to receive their respective first bootstrap message. In response to receiving the respective first bootstrap message, each network node assumes a major rank that is increased by 1 over the major rank received in the first bootstrap message, and itself broadcasts a bootstrap message, announcing its respective assumed major rank. The bootstrap message broadcast by the network nodes in response to receiving the respective first bootstrap message is, again, received by up to n neighbouring network nodes within direct communication range of the respective network node that transmitted the bootstrap message, and may represent a first bootstrap message to one or more of those neighbouring network nodes. This process is repeated along the linear arrangement of network nodes until the bootstrap message reaches the last node at the opposite end of the linear arrangement of network nodes, which is also referred to as the Leaf node. Eventually, each one of network nodes of the linear arrangement of network nodes will receive, at some point in time, a first bootstrap message that announces a major rank. As each network node rebroadcasts its own bootstrap message, each one of the network nodes of the linear arrangement of network nodes will also receive further bootstrap messages, i.e., bootstrap messages received after having received the first bootstrap message. Up to 2*n network nodes can receive a bootstrap message from a transmitting network node. It is, however, readily apparent that, if a network node does not have n neighbouring network nodes at either side, the number of network nodes that receive a broadcast is lower than 2*n. Each network node may receive up to 2*n−1 further bootstrap messages, i.e., bootstrap messages after having received the first bootstrap message, and each network node will store the major ranks received in these further bootstrap messages. After having received bootstrap messages from at least n neighbouring network nodes, and/or upon a predetermined timeout period that was started in response to receiving the first bootstrap message having expired, each network node computes its minor rank from the received and stored major ranks.

During the determination and assigning phase multiple network nodes may assume the same major rank, as multiple network nodes may receive the same bootstrap message from the same node upstream in the linear arrangement, and any intermediate node will only announce its rank after it has incremented the major rank. Incrementing and broadcasting the major rank in the intermediate node takes longer than the time the signal of the upstream node needs to reach the second next node. Thus, the second next node will increment the rank based on the first bootstrap message received from the node upstream in the linear arrangement, rather than based on the subsequently received bootstrap message of the intermediate node. Both the intermediate and the second next node will then broadcast the bootstrap message announcing the same rank they assumed. However, in order to allow for a proper communication, it is necessary to distinguish all nodes and to exactly know their relative position within the linear arrangement. While the fact that signals are transmitted via a direct communication connection that reaches more than one network node has caused the double assignment, this property of the communication connection can also be used for sorting out the double assignment. Assuming that transmitted signals can be received by two network nodes in either direction, i.e., upstream or downstream of the linear arrangement, for example due to the attenuation of the wireless signal, due to a specific arrangement or connection of the transmitters and receivers, or for other reasons, and knowing that no two nodes will be in the exact same location or position within the linear arrangement, each node will receive at least one bootstrap message from a node within the linear arrangement that announces a different major rank, either a higher one or a lower one. Taking into account the major ranks broadcast by their respective neighbouring network nodes it is now possible for a node to find out whether it is located closer or farther away from the first node than another node that had broadcast the same major rank. Throughout this specification, upstream may refer to a direction in the linear arrangement of network nodes, from which a message is received that is meant to travel down the linear arrangement of network nodes. Accordingly, downstream may refer to a direction in the linear arrangement of network nodes, in which network nodes have not yet received the message.

For sorting out improper double assignment the major ranks may be complemented by a minor rank. If a node has received bootstrap messages from two neighbours that announce a lower major rank than its own rank, it will be located closer to the first node than the other one that has assumed the same rank, and consequently assumes a minor rank of 1. Otherwise, if the node has received bootstrap messages from two neighbours that announce a higher major rank it is located farther away from the first node and assumes a minor rank of 2. In the case a node does not have two neighbours that announced the same rank, which may for example happen at the ends of the linear arrangement, it will assume a minor rank of 2 by default, except if it is neighbour to the node having a major rank of 0, in which case it will assume a minor rank of 1 instead.

A network node may transmit a unique static identifier with the bootstrap message, e.g., a MAC address or the like, allowing, e.g., for identifying bootstrap messages that may be repeatedly transmitted by the same network node, which may be ignored.

In one or more embodiments of the method, each network node waits for a backoff time randomly selected from a backoff time interval before broadcasting its own bootstrap message. This may help avoiding collisions of rebroadcast bootstrap messages from two network nodes that both have received their first bootstrap message.

In one or more embodiments of the method the lower limit of the backoff time interval is increased, from an initial lower limit, with increasing major rank, while keeping the backoff time interval length constant or also increasing the backoff time interval. This may help ensuring that bootstrap messages from all network nodes are properly received prior to computing the minor ranks and thus avoid wrong computation of minor ranks in network nodes located further away from the first node in the linear arrangement of network nodes. The time that expires before a network node may send its own bootstrap message may amount to the respective backoff time selected from within the backoff time interval plus the processing time in the respective node required for assuming the major rank.

The predetermined timeout period that needs to expire prior to a network node computing its minor rank may be calculated as twice the number n of neighbouring nodes that are located within the direct communication range multiplied by the maximum value of the respective backoff time interval. However, the predetermined timeout period may also be configured by a corresponding value broadcast in the bootstrap message.

In one or more embodiments of the method, each network node repeats broadcasting its own bootstrap message y times, with y≥0 preset in all network nodes upon deployment, wherein any repetition occurs only after a bootstrap time period T_{b} has expired. Repeated broadcast of bootstrap messages may enhance the resilience of the process, compensating for lost messages. The number of repetitions may, e.g., be set according to expected disturbances of the communication or an error rate of the communication channel. The bootstrap time period T_{b} is preferably selected long enough to ensure that the repeated bootstrap messages do not interfere with the previously sent bootstrap messages at any point within the respective direct communication range. For example, the bootstrap time period T_{b} may not be shorter than 2*n+1 times the initial upper limit of the initial backoff time, plus a non-zero safety margin in case the lower limit of the backoff time interval is increased with increasing major rank. Waiting for the bootstrap time period to expire prior to repeating broadcasting bootstrap messages ensures that a network node at the extreme end of the direct communication range of a transmitting network node does not receive a repeated bootstrap message before all network nodes downstream in the linear arrangement of network nodes have broadcast their bootstrap messages. The numbery of repetitions may be preset prior to arranging the network nodes in the linear arrangement of network nodes or may be communicated to the network nodes in the bootstrap messages or later messages.

In one or more embodiments of the method that network node that has received only bootstrap messages, including the first bootstrap message, announcing a lower major rank than its own assumed major rank, and after the bootstrap time period T_{b} for the last of the y repetitions has expired, will broadcast a bootstrap complete message. This network node, which is located at the opposite end of the linear arrangement of network nodes from the sink node, may be referred to as the leaf node. Like the bootstrap message, the bootstrap complete message will be received by up to n network nodes in the direction of travel of the message, and each network node will broadcast the bootstrap message after a backoff time, determined as described further above, has expired. The bootstrap complete message will travel in the opposite direction of the bootstrap message along the linear arrangement of network nodes, until it eventually arrives at the first network node, and is ultimately communicated to the sink node and/or to a central or control node.

The leaf node may repeat broadcasting the bootstrap complete message, if it did not receive any further message within a predetermined time period after initially broadcasting the bootstrap complete message. The further message may, for example, be a command that puts the network nodes into the first mode of operation.

At this point the linear arrangement of network nodes is fully configured and ranked, i.e., each of the nodes has determined its rank, each node knows at least the ranks of the neighbouring nodes with which it can directly communicate, i.e., the nodes within direct communication range, preferably of all nodes in the linear arrangement of network nodes. The ranks of the nodes permit unambiguously locating the position of each network node within or along the linear arrangement of network nodes, or at least in relation to their neighbouring nodes within direct communication range. Any defective intermediate network node can be identified by analysing the ordered sequence of major and minor ranks of the nodes, which would look different from the regular one in case one intermediate node does not broadcast the bootstrap message.

Messages may now be exchanged between individual nodes or broadcast along the entire linear arrangement of network nodes. In order to allow for proper transmission of messages over multiple hops and to prevent access collisions on the shared communication medium, and further to ensure that each node can transmit a message during a communication period, the nodes use a kind of ordered access, in which nodes are permitted to transmit in accordance with their relative position along the linear arrangement of nodes. In accordance with the invention all messages are transmitted by broadcasting and rebroadcasting, respectively, through nodes along the linear arrangement of network nodes, and even though the direct communication range may cover several nodes in either direction, rebroadcasting a message without skipping intermediate nodes may be preferable, inter alia for redundancy reasons.

Accordingly, a method of transmitting messages between nodes arranged in a ranked linear arrangement of network nodes, e.g., ranked in accordance with embodiments of the method described above, which nodes are configured to directly communicate with two or more neighbouring nodes in either direction of the ranked linear arrangement of network nodes, comprises broadcasting, by a source node having a first rank, a first message, wherein the first message includes the rank of the source node and the rank of a first destination node. If the rank of the first destination node is higher by two or more than that of the source node, all intermediate nodes whose respective rank is higher than that of the source node and lower than that of the first destination node rebroadcast the message, in accordance with their ascending ranks and beginning with the intermediate node whose rank is higher by one than that of the source node. If the rank of the destination node is lower by two or more than that of the source node, all intermediate nodes whose rank is lower than that of the source node and higher than that of the first destination node rebroadcast the message, in accordance with their descending ranks and beginning with the intermediate node whose rank is lower by one than that of the source node. It is obvious that, if the destination node is the next neighbouring network node, rebroadcasting by other network nodes is not necessary. The first message will be received by the first destination node at least when the first intermediate node within direct communication range of the first destination node has rebroadcast the message. However, the rebroadcasting will be repeated by all remaining intermediate nodes.

In accordance with one or more embodiments of the method of transmitting messages, despite having already received the first message from a node that has a rank that is higher or lower than its own rank by at least two, respectively, the intermediate nodes rebroadcast the first message only after having received the rebroadcast of the first message from the node having a rank that is higher or lower by one, respectively, or after not having received a rebroadcast from the node having a rank that is higher or lower by one, respectively, within a predetermined time period. To this end each intermediate node adds an unambiguous identifier to the first message prior to rebroadcasting, e.g., its own rank, that identifies the respective node and, thus, its location within the linear arrangement of network nodes or with respect to its neighbouring network nodes, and allows for the other nodes to determine whether and when their turn for rebroadcasting has come.

In accordance with one or more embodiments of the method of transmitting messages, each intermediate node may append data or a message of its own that is to be travelling in the same direction of travel as the first message, to a received message prior to rebroadcasting, optionally including a rank or identifier of a respective destination node if the destination node of the appended message or data is different from that of the first message. The same direction of travel in this context is to be understood in relation to the first message travelling in the direction of ascending or descending ranks along the linear arrangement of network nodes.

In a special case, the first message is always transmitted by a node at a very end of the linear arrangement of network nodes, and the destination node is always the node at the respective opposite end of the linear arrangement of network nodes. In this special case a source and a destination node need not be provided in the message. However, any node that rebroadcasts the message either still has to add its own unambiguous rank or identifier, irrespective of whether or not it also adds a message or data, for proper rebroadcasting in accordance with the inventive method.

As each intermediate node always appends or adds its rank or an unambiguous identifier to a message prior to rebroadcasting a message, all nodes receiving a message may find out whether or not and when, if applicable, to rebroadcast a message. This may involve, inter alia, parsing the received message for the rank of the source node, for the rank of the destination mode or, in case further messages for other destination modes are travelling together in one message, for the ranks of the destination modes, and/or for unambiguous identifiers of nodes that had transmitted or rebroadcast the message. Any message or data that had been added by rebroadcasting nodes may be ignored except by the respective destination node. Network nodes that do not lie in the direction of the first destination node may refrain from rebroadcasting any message. This may occur, e.g., if a source node is not located at a very end of the linear arrangement of network nodes.

In accordance with one or more embodiments of the method of transmitting messages, any destination node removes the message that was intended for it and broadcasts any appended messages destined for destination nodes in the direction of travel of the first message. Even if no further message remains for rebroadcasting, and the last destination node is not a network node at the very end of the linear arrangement of network nodes, the last destination node can nevertheless forward a general message into the direction of travel of the first message, giving all nodes lying in between the last destination node and the respective network node at the end of the linear arrangement of network nodes the opportunity to transmit their own messages. The general message may carry the rank of the network node at the respective end of the linear arrangement of network nodes in order to properly maintain the direction of travel of the first message.

The messages may, e.g., have a frame structure based on the IEEE 802.15.4 standard format, which was developed with a focus on efficient communication in smaller networks.

The method of transmitting messages, or protocol, presented hereinbefore does not use acknowledgment messages, which would have negative impact on the energy consumption and the time messages need for travelling across the linear arrangement of network nodes. Also, any access control signalling is always implicit, taking advantage of the shared transmission medium and the linear arrangement of nodes. As messages are forwarded through the ranked network by broadcast, i.e., in both directions along the linear arrangement of a node that had broadcast, the protocol and the knowledge of the location of the neighbouring network nodes within direct communication range will ensure that only the node that lies in the communication direction will rebroadcast the message. The implicit access control keeps communication overhead low and also reduces the energy consumption, as transmissions for signalling are avoided. The direct communication range n being two or greater, i.e., transmissions may reach two or more network nodes in either direction along the linear arrangement of network nodes, together with the fallback options provided for in the method of transmitting messages, provides for multiple possible paths and thus adds resilience to systems that use the method.

Since the broadcast messages are received in either direction along the linear arrangement of network nodes, the nodes that had already transmitted or rebroadcast the message may use the rebroadcast messages of nodes upstream or downstream in the linear arrangement of network nodes, respectively, as an implicit acknowledgement of receipt. For example, when messages are transmitted from nodes having higher ranks to nodes having lower ranks, the node having a higher rank listens to the broadcast of the node having a lower rank and can verify the message content, without using any explicit acknowledgement or other signalling. If a node fails to rebroadcast, this failure can be identified, and an error map may be generated. If a node repeatedly fails to rebroadcast, the error map may be used for servicing, rerouting or the like. Accordingly, a method of locating a fault in a ranked linear arrangement of network nodes, whose network nodes are configured to directly communicate with two or more neighbouring nodes in either direction of the linear arrangement of network nodes, but in which no network node can directly communicate with all network nodes, comprises transmitting, through a network node at one end of the linear arrangement of network nodes, a topology checking message. Each node that receives the topology checking message rebroadcasts it after appending a topology checking message of its own. Rebroadcasting through each respective network node is coordinated in the way described further above, i.e., each network node rebroadcasts its own compound topology checking message only after it has received a topology checking message or compound topology checking message from an immediate neighbour upstream of the direction of travel in the linear arrangement of network nodes or if a rebroadcast of the topology checking message from an immediate neighbour in the linear arrangement of network nodes upstream of the direction of travel of the topology checking message is not received after the backoff time interval has expired. All intermediate network nodes of the linear arrangement of network nodes rebroadcast the compound topology checking message. The network node at the opposite end of the linear arrangement of network nodes may analyse the compound topology checking message for identifying broken wireless connections. Any network node whose rank does not show up in the compound topology checking message may be considered defective.

In an exemplary linear arrangement of network nodes of six network nodes ranked 1 to 6, with the network node 4 defective this may look as follows. network node 1 broadcasts the topology checking message, which is received by network node 2. network node 2 rebroadcasts the topology checking message from network node 1, after appending its own topology checking message. network node 3 receives the topology checking messages of network nodes 2 and 3, appends its own topology checking message and broadcasts the compound topology checking message. As network node 4 is defective, network node 5 receives the compound topology checking messages from network nodes 1, 2 and 3, waits for the backoff time interval to expire, and transmits the topology checking messages of the first three network nodes after appending its own topology checking message. network node 6 receives topology checking messages from network nodes 1 to 3, and 5, and can immediately identify network node 4 as defective.

As each network node knows its rank and that of the n network nodes within direct communication range, receives the topology checking messages from all network nodes within direct communication range and rebroadcasts the topology checking message when its turn has come, it will be possible to identify up to n−1 broken communication links between network nodes within direct communication range while still being able to send the topology checking message along the entire linear arrangement of network nodes. If one or more neighbouring network nodes upstream in the direction of travel of the topology checking message fail to rebroadcast the topology checking message, a network node downstream in the direction of travel will wait for a predetermined time period before rebroadcasting the topology checking message. topology checking messages may be sent in either direction from one end of the linear arrangement of network nodes to the respective opposite end. It may be advantageous to regularly send topology checking messages in both directions, i.e., forth and back, for checking the integrity of the linear arrangement of network nodes. The result of analysing the compound topology checking messages received by the network node at the opposite end of the linear arrangement of network nodes may be returned to the initiator in a regular message. Alternatively, the last network node that received the topology checking message may simply add a further topology checking message to the compound topology checking message that it received, and broadcast it into the linear arrangement of network nodes, where it will be rebroadcast as described above, only in the opposite direction of travel, i.e., back to the first network node. In the end, the first network node, i.e., initiator of the first topology checking message, will receive a compound topology checking message in which all intermediate network nodes should show up twice in case no network node was defective. Otherwise, defective network nodes will be missing at least once. The returned topology checking message may be identified by the intermediate network nodes by analysing the ranks of the network nodes that had appended topology checking messages of their own.

As all network nodes receive up to n rebroadcast topology checking messages by network nodes downstream in the direction of travel, and know their respective position in the linear arrangement of network nodes, it will also be possible to detect if n consecutive network nodes are defective, based on the missing rebroadcast topology checking messages. In this case, a network node that does not receive a rebroadcast from one of the up to n network nodes known to be located downstream in the direction of travel of the topology checking message broadcasts a topology checking message error message, which is rebroadcast, in the opposite direction of travel of that of the topology checking message, by all intermediate network nodes located between the network node that broadcast the topology checking message error message and the first network node. As the topology checking message error message contains the rank of the network node that sent it, the first network node will be able to identify the first defective network node and all defective network nodes within the direct communication range. Obviously, it is not possible to obtain any information from network nodes located behind the defective network nodes.

After the topology checking message has indicated an error, the process of determining and assigning ranks may be repeated. other messages that are transmitted across the entire linear arrangement of network nodes may also be used for the purpose of a topology checking message, if all intermediate nodes append at least their rank to a received message prior to rebroadcasting. This allows for the network node that finally receives the compound message to verify if the operating mode of each network node has been properly toggled, and if the transceiver of each network node is functional. When the method of locating faults is repeated in appropriate intervals, dynamically changing arrangements of network nodes in the linear arrangement of network nodes may be accounted for. Such dynamically changing arrangements may, for example, occur in trains, where coaches or wagons are randomly arranged for each trip, in trucks or other land vehicles that temporarily drive along the same route, with the leading vehicle controlling the trailing vehicles or at least providing information about the road ahead to the trailing vehicles, often referred to as platooning, in unmanned aerial vehicles, or drones, that temporarily fly in groups, in industrial environments, in which mobile robots operate in groups, and last but not least in marine applications, where coupled hose segments that are equipped with sensors and communication nodes are in constant motion, which may cause network nodes to be in direct contact with changing network nodes.

In linear arrangement of network nodes in which nodes are battery-powered, and that cannot easily be accessed for recharging or replacing batteries, as well as in other applications, conserving energy may be an important issue. In particular the energy that is used by the transceivers even when not actively transmitting, but being in a receive-only mode, may be significant compared to the energy that is consumed by other components of the network node. Therefore, at least the transceivers of network nodes may be inactivated or powered down when not needed, and may be activated or powered up only when needed. It goes without saying that other components of a network node may be inactivated or powered down and activated or powered up, respectively, along with the transceivers.

As messages travel along the nodes of the linear arrangement of network nodes through coordinated rebroadcasting by nodes in the direction of travel of a message, nodes that are in a power saving mode must be switched to the second operating mode, in which receiving and transmitting messages is possible, in a coordinated manner, before returning to a power saving mode.

Accordingly, a method of coordinated switching network nodes arranged in a fully configured and discovered linear arrangement of network nodes, which directly communicate with up to n neighbouring network nodes, between a first operating mode, in which at least the transceiver is inactive or powered down, i.e., consumes no or only very little energy while not being able to receive or transmit, and a second operating mode, in which at least the transceiver is active or powered up, i.e., is able to receive or transmit, but accordingly consumes more energy than in the first operating mode, comprises broadcasting, by a first network node of the linear arrangement of network nodes, a duty cycle message (duty cycle message) into the linear arrangement of network nodes, wherein the duty cycle message includes at least a wakeup time that defines when to switch the network nodes to the second operating mode, and coordinated rebroadcasting the duty cycle message by all network nodes of the linear arrangement of network nodes, e.g., in accordance with the method of transmitting messages presented above.

The first network node may itself receive a command or an instruction to broadcast the duty cycle message from a sink node or a central control node, which may define the wakeup time. The wakeup time may be defined as an absolute time or as a time period that is to expire after a trigger event, e.g., after the duty cycle message has been rebroadcast and a rebroadcast from a neighbouring network node further down the linear arrangement of network nodes has been received. Here, like throughout the entire description, the expression further down or further up in the context of messages passed along the linear arrangement of network nodes refers to a direction of travel of a message, i.e., further down may refer to network nodes at locations in the linear arrangement of network nodes, towards which the message is travelling, while further up may refer to network nodes at locations in the linear arrangement of network nodes from which the messages have been received.

After having rebroadcast the duty cycle message a network node may switch to the first operating mode, and it will switch to the second operating mode in accordance with the wakeup time received in the duty cycle message.

Any of the first and the intermediate network nodes may repeat broadcasting or rebroadcasting the duty cycle message if it does not receive a rebroadcast of the duty cycle message from one or all network nodes further down the linear arrangement of network nodes that are within direct communication range after a predetermined time period has expired, e.g., at the end of the respective backoff time periods of all network nodes within direct communication range. Generally, the time period to expire prior to repeating the broadcast or rebroadcast of the duty cycle message should be chosen such that it provides sufficient time for the rebroadcasts of the network nodes downstream along the linear arrangement of network nodes to be received while at the same time ensure that the network nodes downstream had not yet entered the first mode of operation. The number of repetitions of the duty cycle message may be selectable in accordance with the communication channel quality, i.e., may be set higher in case of a less reliable communication channel that exhibits a higher error rate. A network node may only switch to the first operating mode if it has received a rebroadcast of the duty cycle message from one or all network nodes further down the linear arrangement of network nodes that are within direct communication range.

Alternatively, or in addition to the wakeup time, the duty cycle message may also include a sleep time that defines when a network node is to switch to the first operating mode, after having rebroadcast the duty cycle message at least once. Like the wake-up time the sleep time may be an absolute time or a time referred to a trigger event.

As the network node at the very end of the linear arrangement of network nodes knows, from the bootstrap phase, that there is no further network node further down the linear arrangement of network nodes, this network node may switch to the first mode of operation after having rebroadcast the duty cycle message, for informing the neighbouring network node that the duty cycle message has been received, and in accordance with the sleep time provided in the duty cycle message, if applicable. Alternatively, like any other network node, the network node at the very end of the linear arrangement of network nodes may simply switch to the first operating mode after having repeated its rebroadcasting of the duty cycle message for the predetermined number of times and after not having received rebroadcasts from network nodes further down the linear arrangement of network nodes, which, quite obviously, do not exist for the network node at the very end of the linear arrangement of network nodes.

In one or more embodiments, a network node may only switch to the first operating mode after having broadcast or rebroadcast the duty cycle message if it has itself received rebroadcasts of the duty cycle message from one or all network nodes further down the linear arrangement of network nodes that are within direct communication range at the end of the respective backoff time periods.

The duty cycle message may also include a duration of an active time period, during which a network node is in the second operating mode, after waking up as specified in the wakeup time, before returning to the first operating mode. Alternatively, the network nodes may remain in the second operating mode after waking up until they receive a further duty cycle message indicating a new wakeup time.

The wakeup time, the sleep time and/or the duration of the active time period may be identical for all network nodes, i.e., all network nodes are in the same operating mode simultaneously. Alternatively, the wakeup time, the sleep time and/or the duration of the active time period may be adjusted for the respective positions of the network nodes in the linear arrangement of network nodes and the direction of travel of a message, in order to ensure that a respective network node is in the second operating mode long enough for receiving a message and transmitting a response, if applicable. The adjustment may take the time required for the transmission itself into consideration, which may be significant in direct communications having a low data rate, and may also take the processing time in the respective network nodes into consideration. Further, the adjustment may take into account that intermediate network nodes may add their own messages to the respective received message, which will lead to a growing amount of data that has to be transmitted as the message is passed via the network nodes of the linear arrangement of network nodes. Different wakeup times across the linear arrangement of network nodes may be considered as a “sliding window” during which the network nodes within the sliding window are in the second operating mode, and the window slides along the linear arrangement of network nodes with the transmitted message.

The first duty cycle message is preferably transmitted right after the linear arrangement of network nodes is fully configured and discovered, and all nodes know their respective rank. In case a duty cycle message, or a message of a different kind, is not received at the leaf node within a predetermined time period after the leaf node had transmitted the bootstrap complete message, the leaf node will resend the bootstrap complete message.

The method of transmitting messages presented above achieves a resilient and fast transport of information along the linear arrangement of network nodes, while reducing the likelihood of colliding transmissions that may occur in a shared communication medium. In comparison to a protocol that uses timeslots, where all network nodes need to maintain very accurate clocks, the coordinated switching between the first and the second modes of operation and the asynchronous communication may be more energy efficient, notably in linear arrangement of network nodes in which messages are transmitted sparsely and/or in irregular time intervals. Also, the arbitrarily settable durations and frequencies of switching to the second mode of operation, during which messages can be transmitted and received, bring about a great flexibility for a plurality of use cases. The automatic discovery of the arrangement of the network nodes within the linear arrangement of network nodes dispenses with the need to always arrange network nodes in a predetermined order, or to manually program a specific order of arrangement to each network node.

In case a network node fails to rebroadcast due to a failure the message will still be passed across the linear arrangement of network nodes, irrespective of whether a neighbouring transmitting node is inoperative or a message is not received in a node and can, therefore, not be rebroadcast. In this case the linear arrangement of network nodes will continue to operate as defined by the duty cycle message. If a node is inoperative its message simply will not be part of the aggregated messages that are transmitted across the linear arrangement of network nodes. On the other hand, if a message fails to reach a in intermediate network node, the message should be received by the other neighbour within communication range.

### BRIEF DESCRIPTION OF THE DRAWINGS

In the following section the invention will be described with reference to the drawings.

FIG. 1 shows a simplified flow diagram of an exemplary method of operating an arrangement of a plurality of network nodes that are randomly arranged in a linear arrangement of network nodes.

FIGS. 2a, 2b, and 2c show an exemplary schematic linear arrangement of network nodes during various phases of determining and assigning ranks in accordance with one or more embodiments of the invention.

FIG. 3 shows a first message flow diagram between the network nodes during various phases of determining and assigning ranks.

FIG. 4 shows a diagrammatic flow diagram of an exemplary method of determining and assigning an unambiguous individual rank to each one of a plurality of network nodes of the linear arrangement of network nodes.

FIG. 5 shows a second message flow diagram between the network nodes during various phases of determining and assigning ranks.

FIG. 6 shows an example of messages travelling from one end to the opposite end of a linear arrangement of network nodes.

FIG. 7 shows a part of a first exemplary message flow for switching the network nodes into the first mode of operation in accordance with a duty cycle message.

FIG. 8 shows a part of a second exemplary message flow for switching the network nodes into the first mode of operation in accordance with a duty cycle message.

FIG. 9 shows a schematic and exemplary arrangement of network nodes along a hose line that is composed of coupled hose segments.

FIG. 10 shows a schematic and exemplary flow diagram of a method of locating a fault in a linear arrangement of network nodes operated in accordance with one or more embodiments of the present invention.

FIG. 11 shows a simplified block diagram of a network node in accordance with one or more embodiments of the present invention.

In the figures identical or similar elements may be referenced using the same reference symbol.

### DETAILED DESCRIPTION

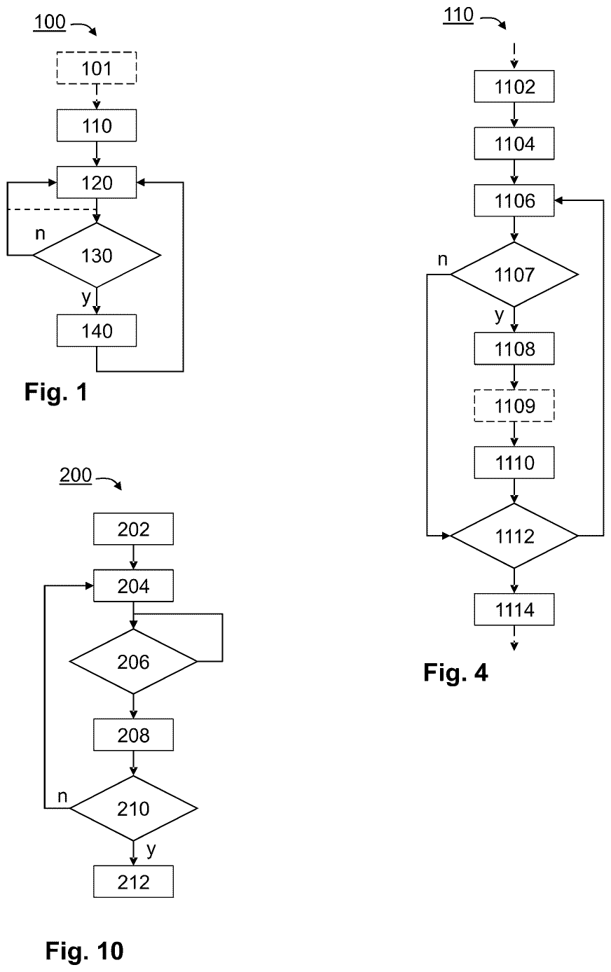

FIG. 1 shows a simplified flow diagram of an exemplary method 100 of operating an arrangement of a plurality of network nodes A through F that are randomly arranged in a linear arrangement of network nodes, in which network nodes are configured to directly communicate with n neighbouring network nodes, but not with all of the network nodes of the linear arrangement of network nodes. In step 101 the network nodes of the linear arrangement of network nodes are powered up and, by default, switch to a second operating mode, in which transceivers of the network nodes are powered and operative. In step 110 an unambiguous and individual rank is determined and assigned to each one of the plurality of network nodes. In step 120 the plurality of network nodes is configured to coordinated toggling between the second operating mode and a first operating mode, in which the power consumption of the network nodes is lower than in the first operating mode, e.g., through switching off such components as the transceivers, which may consume a significant amount of power. In step 130 it is determined if network nodes are in the second mode of operation. If not, “no”-branch of step 130, the method may return to step 120, or simply wait until network nodes are in the second mode of operation. If network nodes are in the second mode of operation, “yes”-branch of step 130, the method continues with step 140, in which messages are transmitted between network nodes of the linear arrangement of network nodes.

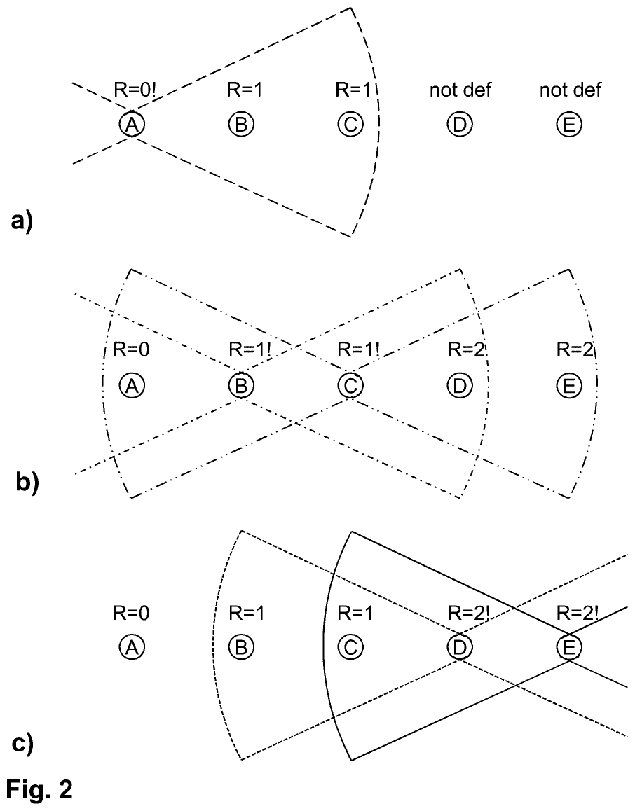

FIG. 2 shows an exemplary schematic linear arrangement of network nodes A through E during various phases of determining and assigning major and minor ranks R, r in accordance with the invention. Each of the nodes may have a unique identifier, e.g., a MAC address or the like, but none of the nodes knows any of its neighbours nor its position within the linear arrangement of network nodes, or major and minor rank R, r. Once all nodes are powered up, they will default to a listening mode. Determining and assigning ranks may begin when a first node located at an end of the linear arrangement of network nodes receives a corresponding signal from a sink node, e.g., through a wired communication connection or generally a communication connection that only reaches the first node. This first node assumes a major rank R of 0.

In FIG. 2 a) node A has assumed a major rank R of 0, and broadcasts a bootstrap message announcing its rank. In the figure an announced rank is indicated by the exclamation mark. In accordance with the inventive method, unlike all other nodes, the first node does not have or need a minor rank r. The sector in the long-dashed line extending to both sides from node A indicates the range of the direct communication connection. The signal range may cover a full radius around a node, but it is obvious that in a linear arrangement of nodes this is irrelevant. In this example, the range of the direct communication connection reaches as far as two neighbouring nodes, i.e., nodes B and C.

network nodes B and C assume, in response to receiving the bootstrap message from node A, a major rank R that is higher by 1 than the major rank of node A. In this example, nodes B and C both assume a major rank R of 1. nodes D and E did not yet receive a bootstrap message from any node and remain in listening mode.

Both, node B and node C, in response to having assumed their major ranks R of 1, broadcast their own respective bootstrap message, announcing their own ranks R, as is shown in FIG. 2 b). In order to prevent two nodes from broadcasting their bootstrap message at the same time, each node waits for a backoff time randomly chosen from a backoff time interval before broadcasting its bootstrap message. Whenever a shared communication channel is occupied other nodes within direct communication range will not send, e.g., in accordance with a CSMA/CA mechanism. The respective range of the direct communication from node B and node C, respectively, is indicated by the dash-dotted and dash-double-dotted sectors. The bootstrap message from node B will be received by nodes A, C and D. The bootstrap message from node C will be received by nodes A, B, D and E.

Nodes D and E, both receiving their respective first bootstrap messages, will assume a major rank R that is higher by 1 than the major rank R announced in the first received bootstrap message. In this example, nodes D and E both assume a major rank R of 2.

Like nodes B and C before, nodes D and E, in response to having assumed their major ranks R of 2, announce their assumed major ranks by transmitting their own bootstrap messages, as is shown in FIG. 2 c). The respective range of the direct communication from node D and node E, respectively, is indicated by the short-dashed and solid-line sectors. The bootstrap message from node D will be received by nodes B, C and E, and one node further down the row, if there is one. The bootstrap message from node E will be received by nodes C and D, and one or two nodes further down the row, if there are.

The process shown in FIGS. 2 a) through c) will continue until the last node in the row has transmitted its own bootstrap message.

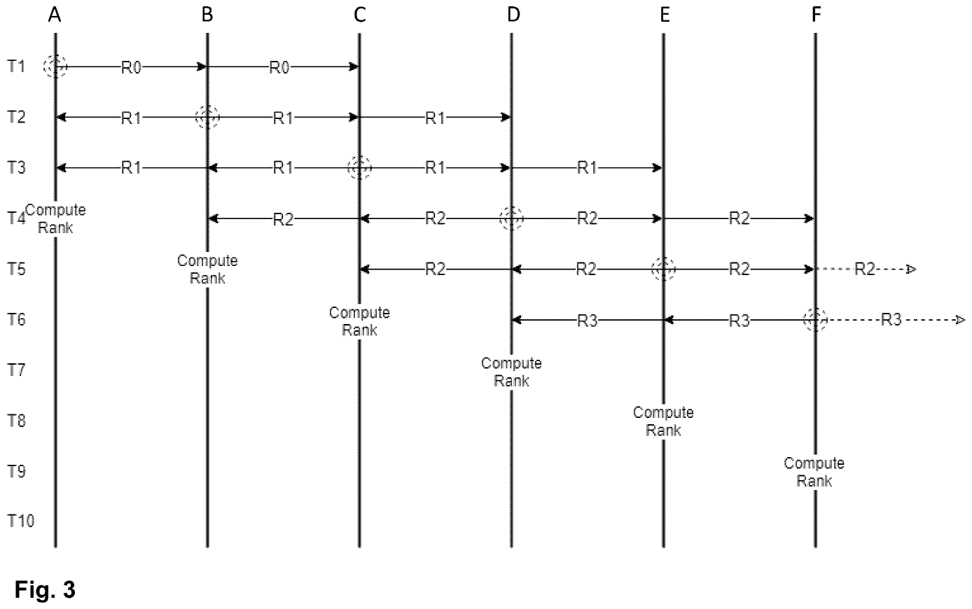

FIG. 3 shows a first message flow diagram between the network nodes during various phases of determining and assigning ranks R_r. In this figure, six nodes A through F are arranged in a linear arrangement of network nodes. The behaviour of the nodes is the same as that of the nodes of FIG. 2. The process of determining and assigning ranks R_r begins after the first node, here node A, has received a corresponding signal. The respective point in time when a node transmits a bootstrap message is indicated by the dashed-line double circle.

At T1 node A transmits its assumed major rank R of 0 in a corresponding bootstrap message, which is received by nodes B and C. nodes B and C accordingly assume major ranks R of 1.

At T2 node B transmits its assumed major rank R of 1, which is received by nodes A, C and D. While node C had already assumed a rank R of 1 in response to the bootstrap message from node A and only records to the rank received in this second bootstrap message, this bootstrap message is the first bootstrap message to node D, which was yet unranked. Therefore, node D increments the major rank R received in the “first” bootstrap message to 2 and assumes this major rank.

At T3 node C also transmits its assumed major rank R of 1 in a respective bootstrap message. This bootstrap message will be received by nodes A, B, D and E. Again, only one node, node E is yet unranked and receives its “first” bootstrap message, the first major rank R it receives being 1. Therefore, like node D before, node E also increments the major rank R received in the “first” bootstrap message to 2 and assumes this major rank.

Then, at T4, node D rebroadcasts the bootstrap message, announcing its major rank R of 2, which will be received by its neighbours, B, C, E and F. node F is yet unranked, and this is the first bootstrap message for node F, therefore it increments the major rank R of 2 received in the bootstrap message to 3 and assumes 3 as its own major rank.

At T5, node E rebroadcasts the bootstrap message, also announcing its major rank R of 2, which will be received by its neighbours, C, D and F.

Finally, at T6, node F rebroadcasts the bootstrap message, announcing its major rank R of 3, which will be received by its neighbours, D and E. Generally, the process continues until the last node in the row has received a bootstrap message, assumed a rank and broadcast its own bootstrap message.

It is to be noted that the sequence of transmission of the respective bootstrap messages depends from the backoff time that each node randomly chooses from a backoff time interval. For better understanding the nodes in the figure are shown transmitting in an alphabetical sequence.

As indicated further above, each network node needs an unambiguous rank, for proper addressing and message passing. This can be achieved by determining the minor ranks r from the totality of bootstrap messages received during this phase of operating the linear arrangement of network nodes. To this end, all nodes that had previously assumed their respective major ranks, in response to receiving a bootstrap message for the first time, will record the rank received in subsequently received bootstrap messages, or further bootstrap messages, for use in determining the respective minor ranks r.

Each node may compute its minor rank r after it has received bootstrap messages from at least n neighbouring nodes and/or upon a predetermined maximum timeout period that was started in response to receiving the first bootstrap message having expired, from the received major ranks R. The following table shows the list of neighbours of each node, at each given time instant as resulting from the message flow shown in FIG. 2. At T10, all nodes have safely and definitely finished the rebroadcast of the bootstrap message, and can now compute their respective minor ranks r.

| | time | | | | | | |
|---|---|---|---|---|---|---|---|
| node | T1 | T2 | T3 | T4 | T5 | T6 | T10 |
| A | sender | (1) | (1), (1) | = | = | = | (1), (1) |
| 0 | 0! | | | | | | |
| B | (0) → 1 | sender | (0), (1) | (0), (1), | = | = | (0), (1), |
| 1.1 | | 1! | | (2) | | | (2) |
| C | (0) → 1 | (0), (1) | sender | (0), (1), | (0), (1), | = | (0), (1), |
| 1.2 | | | 1! | (2) | (2), (2) | | (2), (2) |
| D | —/— | (1) → 2 | (1), (1) | sender | (1), (1), | (1), (1), | (1), (1), |
| 2.1 | | | | 2! | (2) | (2), (3) | (2), (3) |
| E | —/— | —/— | (1) → 2 | (1), (2) | sender | (1), (2), | (1), (2), |
| 2.2 | | | | | 2! | (3) | (3) |
| F | —/— | —/— | —/— | (2) → 3 | (2), (2) | sender | (2), (2) |
| 3(.1) | | | | | | 3! | |

The table is to be read as follows: At T3, node C is the sender and announces a major rank R of 1, indicated by the exclamation mark. Also, at T3, node A has received two bootstrap messages, one from node B at T2, one from node C at T3, both announcing major ranks of 1, and node B has also received two bootstrap messages, one from node A announcing a major rank R of 0, one from node C announcing a major rank R of 1. Receiving is indicated by the rank in parentheses. Node D had previously, at T2, received a bootstrap message and already assumed a major rank R of 2, and now records the received major rank R of 1 transmitted from node C. Node E has received its first bootstrap message, announcing a major rank R of 1, and thus assumes a major rank R of 2, indicated by the arrow. Node F did not yet receive a bootstrap message and has, therefore, not yet assumed a major rank R (−/−).

As stated before, at T10 all nodes have safely and definitely received all bootstrap messages within wireless range and have transmitted their own bootstrap message. Node A has a major rank R of 0 by definition, and does not have a minor rank r, so there is no need to compute.

Assuming a direct communication range of n=2, i.e., two (2) nodes at either side of a transmitting node can receive the transmission, the minor ranks r of 1 or 2 can now be assigned to nodes in accordance with the following set of rules:

For all nodes that received 2n bootstrap messages, in this example four (4), that node that received more bootstrap messages indicating a lower major rank R than its own the minor rank r is set to 1. For all nodes that received 2n bootstrap messages that node that received more bootstrap messages indicating a higher major rank R than its own the minor rank r is set to 2. bootstrap messages announcing identical major ranks R may be ignored.

Nodes located at the respective ends of the linear arrangement of network nodes will receive between n to 2n−1 bootstrap messages.

Of these, all nodes receiving n bootstrap messages will be assigned a minor rank r of 1, except for the node having a major rank R of 0, which does not have a minor rank r, or for which the minor rank r is irrelevant.

All nodes receiving 2n−1 bootstrap messages will be assigned a minor rank r of 2, unless a major rank R of 0 was received, in which case a minor rank r of 1 is assigned.

While the rule for the nodes receiving 2n bootstrap messages should remain valid for all symmetric direct communication ranges, similar rules for the ends of the linear arrangement of network nodes as presented hereinbefore can be found for direct communication ranges n greater than 2.

It is reminded that the individual nodes do not know which other nodes within the direct communication range are located to which side of the linear arrangement of network nodes, they only know the major ranks R of the respective nodes as received through the respective bootstrap messages. For the present example this results in the following minor ranks r being assigned to the nodes:

Node B has received 3 bootstrap messages, one of which announces a major rank R of 0. Accordingly, node B assumes a minor rank r of 1.

Node C has received 2n bootstrap messages, and the general rule applies. As there are more bootstrap messages announcing a higher major rank R than there are bootstrap messages announcing a lower major rank R, node C is assigned a minor rank r of 2.

Node D likewise has received 2n bootstrap messages, and the general rule applies. As there are more bootstrap messages announcing a lower major rank R than there are bootstrap messages announcing a higher major rank R, node D is assigned a minor rank r of 1.

Like node B, node E has received 3 bootstrap messages, i.e., 2n−1, and the special rule applies. Since no major rank R of 0 was received in any of the bootstrap messages, node E is assigned a minor rank r of 2.

Node F has received 2 bootstrap messages, i.e., n, and the special rule for this case applies. Since no major rank R of 0 was received in any of the bootstrap messages, node F is assigned a minor rank r of 1.

The nodes may be configured to repeat transmitting their bootstrap messages y times after waiting for a predetermined bootstrap interval time T_{bi}, in order to make the bootstrap process more tolerant for lost bootstrap messages. m is configurable and will depend, inter alia, on the bit error ratio associated with the communication channel.

After the last repetition, i.e., after y*T_{bi} seconds, each node should have received all bootstrap messages that are needed to compute its major rank R and minor rank r, and should know their location with respect to that of its neighbours. The absolute position of the nodes may be determined by passing an according discovery message through the linear arrangement of network nodes, which may be using the major and minor ranks R, r for addressing, and in which each node appends a unique and unambiguous identifier to the message it received prior to forwarding the message. The network node at the very end of the linear arrangement of network nodes may return the discovery message to the opposite end, and all intermediate network nodes can store a copy of the so-created map of the linear arrangement of network nodes. Alternatively, the nodes may determine their absolute position using an according calculation rule. An exemplary calculation rule for n=2 may look as follows:

$$Rank ( absolute ) = 2 * ( R - 1 ) + r$$

The node having received bootstrap messages from only n other nodes none of which announced a major rank R of 0 is the node that is at the extreme end of the linear arrangement of network nodes. This node, which may be dubbed leaf node, which will also only receive bootstrap messages that announce a major rank that is lower than its own assumed major rank, will confirm the end of the bootstrap process by sending a bootstrap complete message back to the other end of the linear arrangement of network nodes, in the example above back to node A, and from there to a sink node and/or ultimately a central control node that takes control of the communication on the linear arrangement of network nodes.

FIG. 4 shows a diagrammatic flow diagram of an exemplary method of determining and assigning an unambiguous individual rank to each one of a plurality of network nodes of the linear arrangement of network nodes. The method begins, after the network nodes are powered up and in the second operating mode, with step 1102, in which a first network node located at a first end of the linear arrangement of network nodes assumed a first major rank. In step 1104 the first network node broadcasts a bootstrap message into the linear arrangement of network nodes, announcing its major rank. In step 1106 network nodes within the communication range of a broadcasting network node receive a bootstrap message. In step 1107 the network node checks if the received bootstrap message is the first bootstrap message and, in the positive case, “yes”-branch of step 1107, assumes, in step 1108, a major rank that is incremented by 1 over the major rank received in the respective first bootstrap message. In step 1110, after optionally having waited, in step 1109, for a randomly selected backoff time, the network nodes that have received their first bootstrap message and assumed their respective major rank broadcast their freshly assumed major ranks into the linear arrangement of network nodes. If the bootstrap message received in step 1106 is not the first bootstrap message for a respective network node, “no”-branch of step 1107, the method continues with step 1112. In step 1112 each network node checks if it has received bootstrap messages from at least n neighbouring network nodes and/or if a predetermined timeout period that was started after having received the first bootstrap message has expired. If not, the method returns to step 1106, in which the network node waits to receive further bootstrap messages. If the condition of step 1112 is fulfilled, “yes”-branch of step 1112, the network node computes, in step 1114, its minor rank r from the received major ranks R.

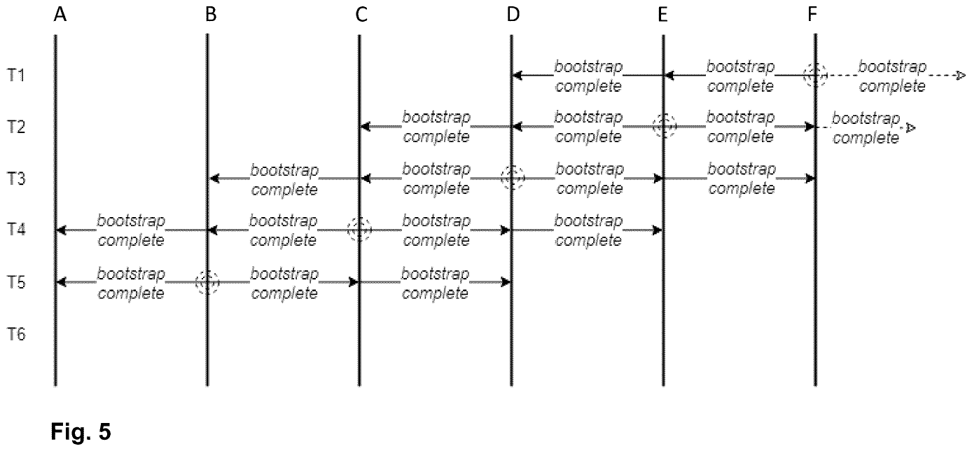

FIG. 5 shows a message flow diagram between network nodes after the bootstrap messages have been repeated y times and have been received by all nodes, and after all nodes have determined their ranks or location within the linear arrangement of network nodes. At T1, node F broadcasts the bootstrap complete message, which will be received by nodes E and D. As each node by now knows its position within the linear arrangement of network nodes, or at least with respect to its neighbours within wireless range, even though node D receives the bootstrap complete message almost at the same time as node E, it will wait for node E to rebroadcast the bootstrap complete message. Only after node D has received the bootstrap complete message from node E, or after a timeout has occurred, will node D rebroadcast the bootstrap complete message. The bootstrap complete message is rebroadcasted accordingly by the other nodes upwards until the bootstrap complete message has been received by node A, representing the opposite end of the linear arrangement of network nodes, and eventually the sink node that is connected to node A. In order to provide some redundancy against lost messages transmitting the bootstrap complete message may be repeated a number of times, very much like the bootstrap message.

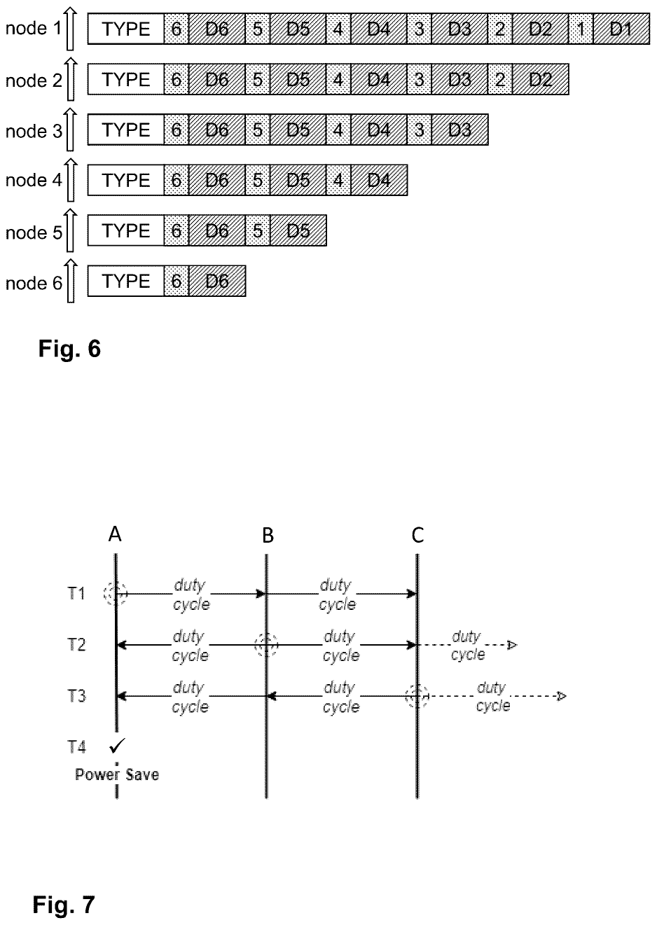

FIG. 6 shows an example of messages travelling from one end to the opposite end of a linear arrangement of network nodes. In this example, a network node having a rank of 6 that may be located at the very end of the linear arrangement of network nodes broadcasts a first message, which is destined to a network node at the opposite end of the linear arrangement of network nodes. The exemplary message includes a field TYPE, indicating, e.g., if the message is a request, or transmits only data, or the like. Next, the exemplary message includes a header that includes, inter alia, a rank of the node that initiated the transmission, in this case the network node has a rank of 6. Finally, the exemplary message includes the message content, in this case data. network node 6 broadcasts the message, and it is received by the network node that has a rank of 5. This network node appends its own header, and its message content, and broadcasts the compound message to the linear arrangement of network nodes. The network node with the rank of 4 receives the message, appends its own header and message content, and broadcast the compound message. The process is repeated until the message arrives at the destination node.

Each transmission may be received by two or more network nodes in either direction. However, since each network node waits until the node having the higher rank—in this example—has broadcast the compound message, it is likely that network nodes may receive duplicated information from its higher ranked neighbours. However, duplicate parts of messages will be discarded by network nodes, and will not be broadcast. If, however, a message is not received from an immediately neighbouring network node within a predetermined time period, e.g., because the network node is offline or permanently or temporarily out of wireless communication range, the message that would otherwise be discarded as duplicate will be broadcast instead. In this case the message or data of the intermediate network node that did not broadcast will not form a part of the compound message.

In this example, all nodes send messages of the same message type. If messages of different type are appended, the type may be also be appended, e.g., between the data field of the previous network node and the rank of the network node that appends the data. Likewise, if the rank of a destination node of an appended message is not the same as that of the first message, the rank of the destination node may be indicated, e.g., in the header.

FIG. 7 shows a part of a first exemplary message flow for switching the network nodes into the first mode of operation in accordance with a duty cycle message. It is assumed that the direct communication range n is 2. At T1 network node A broadcasts a duty cycle message, which is received by network nodes B and C. In accordance with the method of transmitting messages in the ranked linear arrangement of network nodes described further above, network node B will rebroadcast the duty cycle message at T2, and only then network node C will rebroadcast the duty cycle message at T3. network node A will receive both rebroadcasts and only then will switch to the first operating mode, at T4. While the time instants T1 to T4 are shown at equal distances, the rebroadcasting of the duty cycle message can occur at any time within the backoff time interval, and thus the time instances T1 to T3 may vary. T4 may occur immediately after T3, if the condition for switching to the first operating mode is the reception of rebroadcasts from all network nodes within direct communication range. However, if a sleep time is provided in the duty cycle message, this sleep time may be observed alternatively or in addition to receiving rebroadcasts.

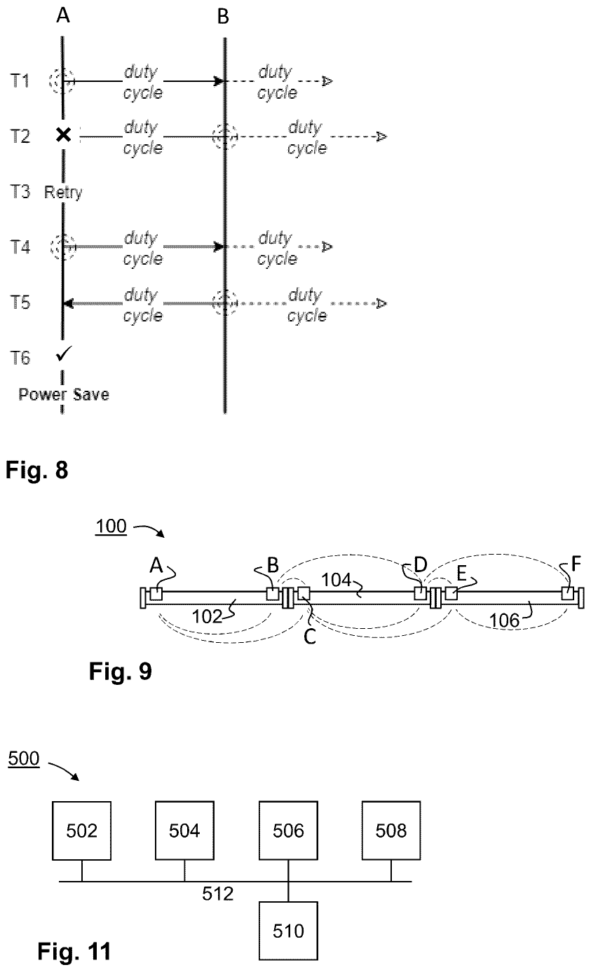

FIG. 8 shows a part of a second exemplary message flow for switching the network nodes into the first mode of operation in accordance with a duty cycle message. In this example the rebroadcast of the duty cycle message by network node B is not received at network node A at T2, i.e., within the backoff time interval, and therefore, at T3 network node A decides that it needs to repeat the broadcast of the duty cycle message. Accordingly, network node A repeats broadcasting the duty cycle message at T4. At T5 network node A receives the rebroadcast of the duty cycle message from network node B, and may switch to the first operation mode at T6 after also having received the rebroadcast of the duty cycle message from network node C (not shown in the figure).

FIG. 9 shows a schematic and exemplary arrangement of network nodes A through F along a hose line 100 that is composed of coupled hose segments 102 through 106. Each hose segment has a network node at each end, which may directly communicate with each other and which may also communicate with the proximal one of the network nodes of a respective coupled hose segment. It is easy to see how messages can be passed from one end of the hose line to the other end by forwarding the messages from one node to the next in line in accordance with the method presented above. The shorter physical connection that may be had when using all intermediary network nodes may be preferred over skipping every other network node for a smaller number of hops, e.g., for increasing the data rate in each individual connection or for reducing errors. Also, using each network node for forwarding the message allows for adding some automatic resilience, as the role of a network node that fails to forward the message will automatically be taken by the next network node within direct communication range, without any additional protocol and signalling effort. For example, if a message is transmitted by network node A it is received by network nodes b and C. Assuming that network node B does not rebroadcast the message, in accordance with the method of transmitting messages presented above network node C will rebroadcast the message after a timeout period. A network node that failed to forward a message can be identified by network nodes further down in the direction of travel of the message, and appropriate actions may be taken in response.

FIG. 10 shows a schematic and exemplary flow diagram of a method 200 of locating a fault in a linear arrangement of network nodes operated in accordance with the present invention. The method 200 is executed while the network nodes are in a second operating mode that allows transmitting messages alone the linear arrangement of network nodes. In step 202 a first network node located at one end of the linear arrangement of network nodes broadcasts a topology checking message into the linear arrangement of network nodes. All intermediate network nodes append, in step 204, a topology checking message of their own to the respective received topology checking message, and wait, in step 206, until they can rebroadcast, in step 208, the compound topology checking message, i.e., the network nodes check if they have received a topology checking message or compound topology checking message from their immediate neighbour network node or if the backoff time period for that network node has expired. The receiving and rebroadcasting generally follows the same principle as the message transmission presented further above. If the topology checking message has arrived at the network node located at the opposite end of the first network node in the linear arrangement of network nodes, “yes”-branch of step 210, the final network node in the transmission chain analyses, in step 212, the received compound topology checking message for missing topology checking messages. Otherwise, “no”-branch of step 210, the rebroadcasting is repeated by the network nodes in the linear arrangement of network nodes that lie upstream of the final network node of the linear arrangement of network nodes.

FIG. 11 shows a simplified block diagram of an exemplary network node 500 in accordance with the present invention. The network node 500 comprises a microprocessor 502, a volatile memory 504, a non-volatile memory 506, at least one communication interface 508, and a power management component 510, which are communicatively connected via at least one data connection or bus 512. The non-volatile memory 506 stores computer program instructions which, when executed by the microprocessor 502, cause the network node 500 to at least execute parts of the methods presented hereinbefore for determining and assigning ranks, for toggling between the first and the second operating modes, for transmitting messages, and/or for detecting faults.

LIST OF REFERENCE NUMERALS

| | |
|---|---|
| 100 | method |
| 101 | power up |
| 110 | determining & assigning |
| 120 | toggling |
| 130 | waiting for 2^{nd} mode of operation |
| 140 | transmitting messages |
| 200 | fault detection method |
| 202 | 1^{st} network node broadcasts |
| | topology checking message |
| 204 | append own topology checking |
| | message |
| 206 | check clear to send? |
| 208 | rebroadcast |
| 210 | end of linear arrangement of |
| | network nodes reached? |
| 212 | analyse compound topology |
| | checking message |
| 500 | network node |
| 502 | microprocessor |
| 504 | volatile memory |
| 506 | non-volatile memory |
| 508 | communication interface |
| 510 | power management |
| 512 | bus |
| 1102 | 1^{st} network node assumes major |
| | rank |
| 1104 | 1^{st} network node broadcasts |
| | bootstrap message |
| 1106 | receive bootstrap message |
| 1107 | check: is 1^{st} bootstrap message? |
| 1108 | assume received major rank +1 |
| 1109 | wait backoff time |
| 1110 | broadcast bootstrap message |
| 1112 | ready to compute minor rank? |
| 1114 | compute minor rank |
| A-F | network nodes |
| R | major rank |
| r | minor rank |

1. A method of operating an arrangement of a plurality of network nodes arranged in a linear configuration, each of which network nodes being configured to directly communicate with n neighbouring network nodes located in either direction of the linear arrangement of network nodes, and in which no network node can directly communicate with each one of the network nodes, wherein the method comprises:
determining and assigning an unambiguous and individual rank to each one of the plurality of network nodes, the rank of each network node having a major rank, and at least one network node having a minor rank, wherein the ranks are orderly increasing from one end of the linear arrangement of network nodes to the other end, and wherein each rank of a network node indicates a position of the respective network node within the linear arrangement of network nodes,
configuring the plurality of network nodes to coordinated toggling between a first and a second mode of operation, a power consumption of the network nodes in the first mode of operation being lower than in the second mode of operation, and
transmitting messages, using a non-synchronised or asynchronous, zero-signalling, stateless multipath and multi-hop message routing protocol, between the network nodes of the linear arrangement of network nodes via those network nodes that are in the second mode of operation.

2. The method of claim 1, wherein determining and assigning an unambiguous individual rank to each one of a plurality of network nodes comprises the steps of:
a first network node, located at a first end of the linear arrangement of network nodes, assuming a first major rank, and broadcasting a bootstrap message to those network nodes of the linear arrangement of network nodes that are within direct communication range, announcing its assumed major rank,
each one of up to n neighbouring nodes to either side of a transmitting network node receiving, at some point in time, a first bootstrap message announcing a major rank, assuming, in response to the first received bootstrap message, a major rank that is incremented by 1 over the major rank received in the first bootstrap message, and broadcasting a bootstrap message of its own, announcing its respective assumed major rank, wherein each network node may receive up to 2*n−1 further bootstrap messages, of which it will store the major ranks transmitted therein,
each network node, after having received bootstrap messages from at least n neighbouring network nodes, and/or upon a predetermined timeout period, which was started in response to receiving the first bootstrap message having expired, computing its minor rank from the received and stored major ranks.

3. The method of claim 2, wherein each node waits for a backoff time randomly selected from a backoff time interval before broadcasting its own bootstrap message.

4. The method of claim 3, further comprising increasing the lower limit of the backoff time interval with increasing major rank, while keeping the backoff time interval length constant or also increasing the backoff time interval.

5. The method of claim 2, further comprising each network node repeating broadcasting its own bootstrap message for a predetermined number of times, wherein any repetition occurs only after a bootstrap time period has expired.

6. The method of claim 5, further comprising:
the network node that has received only bootstrap messages announcing a lower major rank than its own assumed major rank, and after the bootstrap time period T_{bi} having expired, broadcasting a bootstrap complete message into the linear arrangement of network nodes, and
all network nodes rebroadcasting the bootstrap complete message.

7. The method of claim 6, wherein the network node that broadcast the bootstrap complete message repeats broadcasting the bootstrap complete message, if it did not receive any further message, preferably a duty cycle message, within a predetermined time period after initially broadcasting the bootstrap complete message.

8. A method of transmitting messages between nodes arranged in a ranked linear arrangement of network nodes that are configured to directly communicate with two or more neighbouring nodes in either direction of the ranked linear arrangement of network nodes, but wherein no network node can directly communicate with each one of the network nodes, the method comprising:
broadcasting, by a source node having a first rank R_r(s1), a first message, the first message including the rank (R_r(s1)) of the source node and the rank (R_r(d1)) of a first destination node,
wherein the method further comprises:
if the rank of the first destination node (R_r(d1)) is higher by two or more than that of the source node (R_r(s1)):
rebroadcasting, by all intermediate nodes whose rank (R_r(i)) is higher than that of the source node (R_r(s1)), and in accordance with their ascending ranks (R_r(i)), the first message, beginning with the intermediate node whose rank (R_r(i1)) is higher by one than that of the source node (R_r(s1)), or
if the rank of the first destination node (R_r(d1)) is lower by two or more than that of the source node (R_r(s1)):
rebroadcasting, by all intermediate nodes whose rank (R_r(i)) is lower than that of the source node (R_r(s1)), and in accordance with their descending ranks R_r(i), the first message, beginning with the intermediate node whose rank R_r(i1) is lower by one than that of the source node (R_r(s1)).

9. The method of claim 8, wherein an intermediate node rebroadcasts the first message despite having received the first message from a node that has a rank that is higher or lower than its own rank by at least two, respectively, only after having received the rebroadcast of the first message from the node having a rank that is higher or lower by one, respectively, or after not having received a rebroadcast from the node having a rank that is higher or lower by one, respectively, within a predetermined time period.

10. The method of claim 8, wherein each intermediate node may append data or a message of its own that is to be travelling in the same direction of travel as the first message, to a received message prior to rebroadcasting, optionally including a rank or identifier of a respective destination node, if the destination node of the appended message or data is different from that of the first message.

11. The method of claim 8, wherein any destination node removes the message that was intended for it and broadcasts any appended messages destined for destination nodes in the direction of travel of the first message.

12. A method of locating a fault in a ranked linear arrangement of network nodes whose network nodes are configured to directly communicate with two or more neighbouring nodes in either direction of the ranked linear arrangement of network nodes, but in which no network node can directly communicate with all network nodes, the method comprising:
a first network node located at one end of the linear arrangement of network nodes broadcasting a topology checking message into the linear arrangement of network nodes,
all intermediate network nodes appending a topology checking message of their own to a received topology checking message and rebroadcasting the compound topology checking message only after having received the topology checking message from its direct upstream neighbour or after a backoff time period for the direct upstream neighbour has expired, and
a network node at the opposite end of the linear arrangement of network nodes analysing the received compound topology checking message for missing topology checking messages.

13. The method of claim 12, further comprising:
the network node at the opposite end of the linear arrangement of network nodes returning the result of the analysis to the first network node in a regular message, or
the network node at the opposite end of the linear arrangement of network nodes adding a topology checking message of its own to the compound topology checking message it received, broadcasting it, and
all intermediate network nodes between the network node at the opposite end and the first network node appending a further topology checking message of their own to a received topology checking message and rebroadcasting the compound topology checking message only after having received the topology checking message from its direct upstream neighbour or after a backoff time period for the upstream direct neighbour has expired, and
the first network node analysing the received compound topology checking message for missing topology checking messages.

14. The method of claim 12, further comprising, if a network node does not receive a rebroadcast from one of the up to n network nodes known to be located downstream in the direction of travel of a topology checking message:
broadcasting a topology checking message error message,
all intermediate network nodes between the network node that broadcast the topology checking message error message and the first network node rebroadcasting the topology checking message error message.

15. A method of coordinated switching network nodes arranged in a fully configured and discovered linear arrangement of network nodes, which directly communicate with up to n neighbouring network nodes, but in which no network node can directly communicate with each one of the network nodes, between a first operating mode, in which at least the transceiver is inactive or powered down, and a second operating mode, in which at least the wireless transceiver is active or powered up, comprises:
broadcasting, by a first network node located at a first end of the linear arrangement of network nodes, a duty cycle message, wherein the duty cycle message includes at least a wakeup time that defines when to switch the network nodes to the second operating mode, and coordinated rebroadcasting the duty cycle message by all network nodes of the linear arrangement of network nodes,
switching each network node that has rebroadcast the duty cycle message to the first operating mode, and
switching to the second operating mode in accordance with the wakeup time.

16. The method of claim 15, further including, in any of the first and the intermediate network nodes, repeating the duty cycle message, if a rebroadcast of the duty cycle message from one or all network nodes further down the linear arrangement of network nodes that are within direct communication range is not received at the end of the respective backoff time periods, wherein at least the first and the intermediate network nodes only switch to the first operating mode after having received a rebroadcast of the duty cycle message from one or all network nodes further down the linear arrangement of network nodes that are within wireless range.

17. The method of claim 15, wherein a network node only switches to the first operating mode, if it has received a rebroadcast of the duty cycle message from one or all network nodes further down the linear arrangement of network nodes that are within wireless range, or after a predetermined maximum number of repetitions of broadcasting or rebroadcasting the duty cycle message.

18. The method of claim 15, wherein the duty cycle message further includes a duration of an active time period, defining a time period during which a network node is in the second operating mode before returning to the first operating mode.

19. A network node having a microprocessor, associated volatile and non-volatile memory, and a communication interface, wherein, when the microprocessor executes corresponding computer program instructions stored in the non-volatile memory, the node is configured to operate an arrangement of a plurality of network nodes arranged in a linear configuration, each of which network nodes being configured to directly communicate with n neighbouring network nodes located in either direction of the linear arrangement of network nodes, and in which no network node can directly communicate with each one of the network nodes, by performing operations comprising:
determining and assigning an unambiguous and individual rank to each one of the plurality of network nodes, the rank of each network node having a major rank, and at least one network node having a minor rank, wherein the ranks are orderly increasing from one end of the linear arrangement of network nodes to the other end, and wherein each rank of a network node indicates a position of the respective network node within the linear arrangement of network nodes,
configuring the plurality of network nodes to coordinated toggling between a first and a second mode of operation, a power consumption of the network nodes in the first mode of operation being lower than in the second mode of operation, and
transmitting messages, using a non-synchronised or asynchronous, zero-signalling, stateless multipath and multi-hop message routing protocol, between the network nodes of the linear arrangement of network nodes via those network nodes that are in the second mode of operation.

20. A linear arrangement of network nodes comprising at least two network nodes, each network node having a microprocessor, associated volatile and non-volatile memory, and a communication interface, wherein, when the microprocessor executes corresponding computer program instructions stored in the non-volatile memory, the node is configured to operate an arrangement of a plurality of network nodes arranged in a linear configuration, each of which network nodes being configured to directly communicate with n neighbouring network nodes located in either direction of the linear arrangement of network nodes, and in which no network node can directly communicate with each one of the network nodes, by performing operations comprising:
determining and assigning an unambiguous and individual rank to each one of the plurality of network nodes, the rank of each network node having a major rank, and at least one network node having a minor rank, wherein the ranks are orderly increasing from one end of the linear arrangement of network nodes to the other end, and wherein each rank of a network node indicates a position of the respective network node within the linear arrangement of network nodes,
configuring the plurality of network nodes to coordinated toggling between a first and a second mode of operation, a power consumption of the network nodes in the first mode of operation being lower than in the second mode of operation, and
transmitting messages, using a non-synchronised or asynchronous, zero-signalling, stateless multipath and multi-hop message routing protocol, between the network nodes of the linear arrangement of network nodes via those network nodes that are in the second mode of operation.
